(19) United States
(12) Patent Application Publication
(10) Pub. No.: US 2020/0238955 A1
(43) Pub. Date: Jul. 30, 2020

(54) CLEANING SYSTEM FOR OPTICAL SURFACE

(71) Applicant: Jetwipe 2017 IVS, Ebeltoft (DK)

(72) Inventors: Jan Walsøe, Hellerup (DK); Morten Vendelbo Foged, København N (DK); Dan Mønster Nielsen, Ebeltoft (DK)

(21) Appl. No.: 16/635,595

(22) PCT Filed: Jun. 1, 2018
(86) PCT No.: PCT/EP2018/064461

§ 371 Date: Jan. 31, 2020

(30) Foreign Application Priority Data
Jun. 2, 2017 (EP) 17174249.7

(51) Int. Cl. B60S 1/56; B60S 1/54; G02B 27/00

(52) U.S. Cl. CPC B60S 1/56; G02B 27/0006; B60S 1/54

(57) ABSTRACT

A cleaning system for cleaning an optical surface, such as an optical lens of a vehicle camera or sensor, includes at least one nozzle arranged to eject a jet of air towards and/or parallel to the surface; and an outer protective cover layer. The cover layer is mountable on the optical surface and configurable in: a closed configuration, wherein the cover layer and optical surface form a cleaning space between the cover layer and optical surface and the optical surface is protected by the protective cover layer; and an open configuration wherein the optical layer is exposed. A cover assembly is also provided for a vehicle sensor(s) or an image sensitivity part of a camera(s).

### REFERENCE TO RELATED APPLICATIONS

This application is a U.S. national stage application of PCT/EP2018/064461, tiled Jun. 1, 2018, which claims priority to European application No. EP17174249.7, filed Jun. 2, 2017, the entire content of both of which is incorporated herein by reference.

### FIELD OF THE INVENTION

The present disclosure relates to a cleaning system, in particular an air jet-based cleaning system, for cleaning an optical surface, such as an optical lens of a vehicle camera or sensor. The disclosure further relates to a cover assembly for a vehicle sensor or image sensitivity part of a camera.

### BACKGROUND OF THE INVENTION

Vehicles are increasingly in need of sensing its environment for example in order to enhance the driver's vision through cameras, or for autonomous cars capable of navigating partly or completely without human input Autonomous cars use a variety of techniques to detect their surroundings, such as radar, laser light, GPS, odometry, and computer vision. The vehicle sensors typically include an optical surface, such as an optical lens. The optical surfaces are typically placed on a vehicle exterior surface and are often exposed to dirt, mud, ice, dust etc. which may accumulate on the optical surface and deprive the quality of the information provided by the sensor or camera.

There are various types of devices for washing a glass or lens of vehicle-mounted camera,. by applying water or air, However, the known cleaning devices are associated with a number of issues and disadvantages. For example, the air flow, the power efficiency and, the cleaning capabilities are not optimal.

There is thus a need for an improved and more efficient system for cleaning an optical surface, such as an optical lens of a vehicle camera or sensor.

### SUMMARY OF THE INVENTION

Accordingly, it is an object of the present invention to overcome the above mentioned disadvantages of the known systems. The present disclosure relates to, in a first embodiment, cleaning system for cleaning an optical surface, such as an optical lens of a vehicle camera or sensor, comprising:
at least one nozzle arranged to eject a jet of air towards and/or parallel to the surface; and
an outer protective cover layer, said cover layer mountable on the optical surface and configurable in:
   a closed configuration, wherein the cover layer and optical surface form a cleaning space between the cover layer and optical surface and the optical surface is protected by the protective cover layer; and
   an open configuration wherein the optical layer is exposed.

The outer protective cover layer may be configured in the open configuration when the vehicle moves, and/or configured to he in the closed configuration when the vehicle is in a neutral gear and/or when there is no transmission of power to the motor of the vehicle, and/or when the motor does not run. A control unit may control the configurations accordingly. The system may further comprise at least one air flow generator connected to the at least one nozzle trough at least one duct and arranged to generate an air flow to the at least one nozzle. The cleaning system may also be used for other surfaces than an optical lens of a vehicle camera or sensor. Examples of such surfaces may be other optical lenses or covers of sensors or cameras for unmanned aerial vehicles and for robotic purposes. The term ‘optical’ is not to be construed as limited to completely transparent surfaces. Any surface that may be benefit from the presently disclosed cleaning system may use the system, including covers for radars and lidars. Some embodiments of the presently disclosed cleaning system may be used for other purposes than vehicles, for example a motorcycle helmet visor.

In one embodiment the outer protective cover layer is air permeable and transparent and/or translucent. The inventors have realized that if air can flow from the inside to the outside of the outer protective cover layer, dirt can be removed towards the exterior of the outer protective cover layer. The at least one nozzle may thereby by arranged to direct air into the space between the cover layer and optical surface in the closed configuration and out from the space through the air permeable outer protective cover layer.

The cleaning system may be configured to turn the optical surface away from external exposure. This can be achieved for example by a flip-over mechanism. The flip-over mechanism can be activated for example when a vehicle is not used. The optical surface may thereby be an integral part of the cleaning system. In the configuration wherein the optical surface is turned away from external exposure it can be cleaned from the inside of the vehicle, for example through a duct or pipe. From the inside any type of cleaning, including jet-based and brushing can be performed.

In one embodiment the air flow generator is a low-pressure, high-flow air flow generator. A low-pressure, high-flow air pump makes the system more power efficient than the existing high-pressure solutions. If the pressure is a static pressure when the cleaning system operates, the power efficiency may be further improved.

The optical surface may be a substantially circular lens, such as a slightly convex camera lens. For such optical surfaces, the present disclosure presents a number of particularly useful embodiments. The cleaning system may comprise an arm for holding the at least one nozzle, wherein the nozzle is mounted at one end of the arm. The arm may be adjustable and/or controllable to elect the jet of air from various angles and/or distances with respect to the optical surface with respect to the optical surface. By adjusting distances and angles the air jet can be adjusted to operate efficiently on the optical surface. For example, the point from which the air jet is generated may rotate in a circular movement around the surface or clean surfaces which have more dirt than others more thoroughly based on information from the sensor. The arm may also be a robotic arm and may for example be programmed to move in a predefined pattern or in response to input from sensors providing information about e.g. the level of degradation of the surface due to dirt etc.

Moreover, the system may further comprise a protrusion ring around the circular lens. the protrusion ring protruding in the longitudinal projection direction of the lens. The protrusion ring may fur example be shaped as a camera/lens hood. The shape of a lens hood may be plain cylindrical, conical, or having a square or rectangular cross-section. Such a protrusion ring may have several intrinsic functions. The ring may create a local space in front of the lens, which is less exposed to for example wind and the ring could at the same time be used to carry the nozzle(z) on the inside if the ring. The inner space may thereby also be isolated by means of an air curtain covering the optical surface, wherein the air curtain is generated by the nozzle(s). If the air jet is combined with ejection of cleaning fluid, for example by mixing cleaning fluid into the air jet inside the duct, the protrusion ring may comprise draining holes and/or draining slots for evacuating cleaning liquid from the optical lens. The protrusion ring can also serve the purpose of proving channels for the air to be blown. The nozzle may also be mounted in a groove of the protrusion ring, such as a groove in an upper edge of the protrusion ring. This embodiment may provide a more efficient solution from a mechanical perspective compared to an arm.

The disclosure further relates to a cover assembly for vehicle sensor(s) or image sensitivity part of a camera(s), comprising at least one sensor or camera cover, preferably an optical surface for protecting the sensor or image sensitivity part of a camera; and at least one of the above nozzles for cleaning the at least one sensor or camera cover.

### BRIEF DESCRIPTION OF THE DRAWINGS

These and other aspects of the invention are set forth in the following detailed description if the invention.

FIG. 1 shows an embodiment of the presently disclosed air jet-based cleaning system for an optical surface having a protrusion ring with a plurality of nozzles distributed on the inside of the protrusion ring;

FIG. 2 shows another embodiment of the presently disclosed air jet-based cleaning system with a nozzle on the inside of the protrusion ring;

FIG. 3A-B show different shapes of the nozzle(s) on the protrusion ring;

FIG. 4 shows an example of draining slots for evacuating cleaning liquid from the optical lens;

FIG. 5A-B show an embodiment of the air jet-based cleaning system for an optical surface, wherein the duet for providing the air flow is provided in a channel along the longitudinal direction of the optical surface;

FIG. 6 shows an embodiment of the air jet-based cleaning system for a substantially rectangular optical surface, wherein the nozzle is arranged to move back and forth along on of the sides of the surface;

FIG. 7 shows an embodiment of the air jet-based cleaning system for a substantially rectangular optical surface, wherein a plurality of nozzles are arranged to eject overlapping jets of air at a plurality of distances from the optical surface;

FIG. 8 shows examples of jets of air towards the surface from different angles with respect to the optical surface;

FIG. 9 shows an embodiment of the air jet-based cleaning system, wherein cleaning fluid and air are applied by two different nozzles;

FIG. 10 shows embodiments of the air jet-based cleaning system arranged for mixing air and cleaning fluid inside the at least one duct;

FIG. 11 shows an embodiment of the air jet-based cleaning system having an outer protective cover layer which is air permeable;

FIG. 12 shows an embodiment of the air jet-based cleaning system having outer protective cover layer mounted on the optical surface wherein the protective cover layer and optical surface firm a cleaning space; and

FIG. 13 shows an embodiment of the air-jetbased cleaning s ,stem laving a flip-over type optical surface.

### DETAILED DESCRIPTION OF THE INVENTION

The present disclosure relates to a cleaning system for cleaning an optical surface, such as an optical lens of a vehicle camera or sensor, comprising:
at least one nozzle arranged to eject a jet of air towards the surface; and
at least one air flow generator connected to the at least one nozzle trough at least one duct and arranged to generate an air flow to the at least one nozzle.

In particular the system may be applied to a car. Sensors and cameras are often placed on or integrated in autonomous cars. These sensors and cameras would benefit from the presently disclosed cleaning system and cover assembly,

Preferably, the system has the capability of ejecting a cleaning fluid in the jet of air, either in the duct, nozzle or outside the nozzle. The cleaning fluid may comprise hydrophobic liquid, which can be applied to the surface to be cleaned and makes it easier to remove water from the surface. The nozzles and the at least one duct may be used to distribute the hydrophobic liquid over the surface. If the presently disclosed system is equipped with an inlet to the duct and/or nozzles and a mixer for mixing the hydrophobic liquid into the air jet, the mixture can be applied to the surface to be cleaned. The generated air may be hot air or cold air. The system may also be configured to regulate the temperature of generated air flow such that an air flow of a specific temperature is generated for a specific purpose.

A further aspect of the presently disclosed air jet-based cleaning system for an optical surface relates to the ejection of carbon dioxide in the jet of air. Carbon dioxide cleaning (CO₂ cleaning) refers to several different methods for parts cleaning, and each CO₂ phase plays a role. The basic methods include solid dry ice pellets, liquid CO₂, CO₂ snow (a hybrid method), and supercritical CO₂. By designing the present an jet-based cleaning system for an optical surface to apply carbon dioxide into the air flow, particularly difficult dirt spots may be targeted. Such a solution is well suited for a low-pressure, high-flow air pump since the compressed liquid or gaseous carbon dioxide that is expelled from the nozzle is preferred to achieve a gentle but efficient cleaning. The carbon dioxide may be provided as pellets or compressed liquid or gaseous carbon dioxide. The application of carbon dioxide may be done in predefined time intervals and/or upon a sensor indicating a need for more efficient cleaning of the optical surface and/or at request of a user.

Optical Surface, Optical Lens

The optical surface may be any optical surface on a vehicle. In particular it may be part of camera or a cover, preferably a transparent and/or translucent cover, such as the lens, of a camera or a sensor. The optical surface may also be an integral part of the sensor. Transparent may be construed as allowing light to pass through a material without being scattered. Translucent may be construed as allowing light to pass through a material, wherein the photons may be scattered. Any wavelength is possible. A vehicle camera, for example for an autonomous, is sometimes placed on or integrated in the bodywork of the vehicle, Such cameras are typically relatively small, i.e. having a lens diameter ranging from millimeters to centimeters. Typically, such lenses have substantially circular, slightly convex shapes.

High-Flow, Low-Pressure

En one embodiment of the presently disclosed air jet-based cleaning system for an optical surface, the air flow generator is a low-pressure, high-flow air flow generator. This is particularly useful for the present application and ma be achieved by having ducts formed to achieve a venturi effect to increase the speed of the air.

In such a system the generated air flow may be based on a system wherein a pressure inside the system is lower than 10,000 Pa, preferably lower than 7,000, even more preferably lower than 5,000 Pa. Using a relatively low pressure and high flow air pump makes the system power efficient. The cleaning system may be configured to generate an air flow of 50-2000 m³/hour, or 100-1500 m³/hour, or 100-1000 m³/hour or 300-800 m³/hour and/or configured to generate an air flow of 10-200 m/s, more preferably 30-150 m/s, even more preferably 50-130 m/s for air flowing out of the nozzles.

Cleaning System Arm for Nozzle

The cleaning system may comprise an arm for holding the at least one nozzle, wherein the nozzle is mounted at one end of the arm and the arm is adjustable to eject the jet of air towards the surface from variable angles and distances with respect to the optical surface. By adjusting distances and angles the air jet can be adjusted to operate efficiently on the optical surface. For example the point from which the air jet is generated may rotate in a circular movement around the surface or clean surfaces which have more dirt than others more thoroughly based on information from the sensor. This can be achieved by a groove along the circular contour of the lens in which the arm with nozzle can run around the lens, Preferably, the nozzle is directed towards the center of the lens and/or in one direction, such as upwards or downwards, or a combination. Therefore, in one embodiment the system is confirmed for holding and rotating the at least one nozzle around the optical surface.

The adjustable arm for controlling the ejection of the jet of air from various angles and/or distances with respect to the optical surface may be a robotic arm. This kind of robotic arm may be mounted not only a car but could operate in a car wash facility. In particular, in combination with the ejection of carbon dioxide in the jet of air, a very efficient cleaning be achieved.

In one embodiment the cleaning system comprises a plurality of nozzles, wherein groups of nozzles and/or individual nozzles are enabled and disabled and/or adjusted. The enabling and disabling of groups of nozzles and/or individual nozzles can be based on further sensor information. The enabling of one group of nozzles may for example be used to create a specific flow (in terms of direction and amplitude) of air across or towards the surface, or to direct the jet of air to a specific area.

Air Curtain

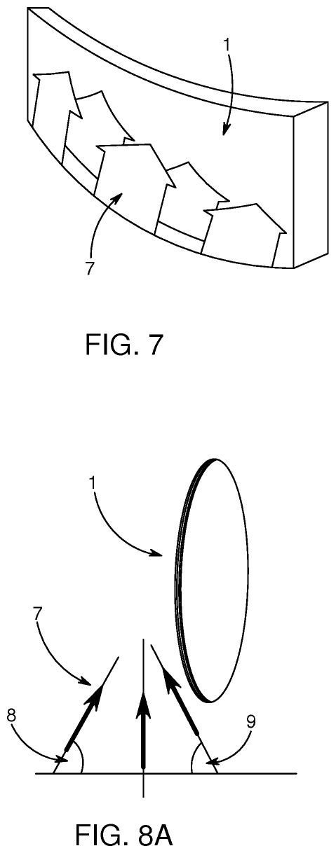

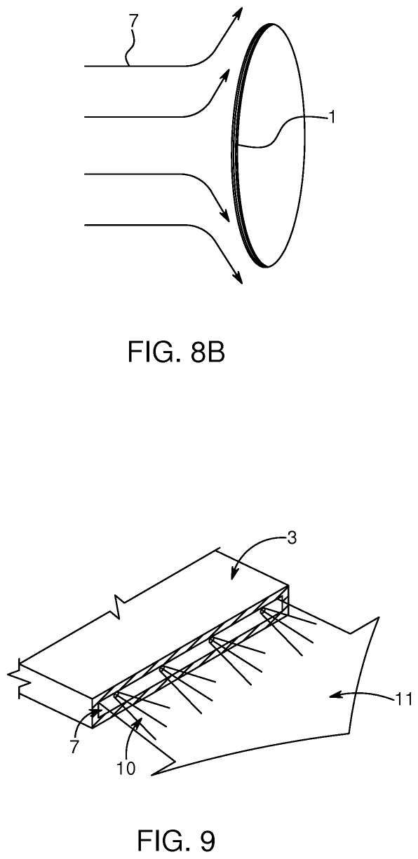

One embodiment of the presently disclosed air jet-based cleaning system for an optical surface is arranged to generate an air curtain covering the optical surface. By arranging the nozzle such that air curtain protects the surface from for example dirt particles to reach the surface, the need of cleaning the surface is reduced. Such an arrangement may involve air-jets parallel to the optical surface in order to create the air curtain. A parallel air curtain may be combined with an air stream towards the optical surface. Such a combination both prevents dirt from reaching the surface and cleans the surface. The angle of incidence of the air jet in relation to the optical surface may be may be 0-±30°, preferably 0-±20°, more preferably 0-±10°, even more preferably 0-±5°. If the surface is convex, the angle of incidence may be calculated in relation to a tangent line (0°) of the middle of a convex surface, as shown in FIG. 8. Alternatively, the nozzles may be configured to generate a jet of air directly towards the optical surface in a direction substantially perpendicular to the optical surface

Protrusion Ring

Vehicle camera lenses may be relatively small, substantially circular, and slightly convex. For such lenses a protrusion ring around the circular lens, the protrusion ring protruding in the longitudinal projection direction of the lens, provides an efficient structure for improving the cleaning of the lens, FIG. 2 shows an embodiment of such a protrusion ring. The ring may provide both a fixed structure from which the nozzles may operate and may be arranged to further improve the air flow characteristics. The protrusion ring creates a space in front of the lens. The arrangement may be configured such that air flows into the space from the nozzle(s) placed on the inside of the ring and away from the space through the open ring formed be the protrusion ring. This configuration prevents dirt from entering the space while the lens is cleaned. In one embodiment the at least one nozzle is/are arranged in the protrusion ring and arranged to eject a jet of air towards the center of the optical surface. In another embodiment a plurality of nozzles are distributed on the protrusion ring, preferably on the inside of the protrusion ring.

The nozzle(s) in the protrusion ring may have are elongate shape, which may create a n ore evenly distributed air flow and also he more power efficient. The elongate shape may take the shape of the protrusion ring, e.g, curved along the protrusion ring. Alternatively the elongate shape may be substantially straight, thereby creating a flat jet of air.

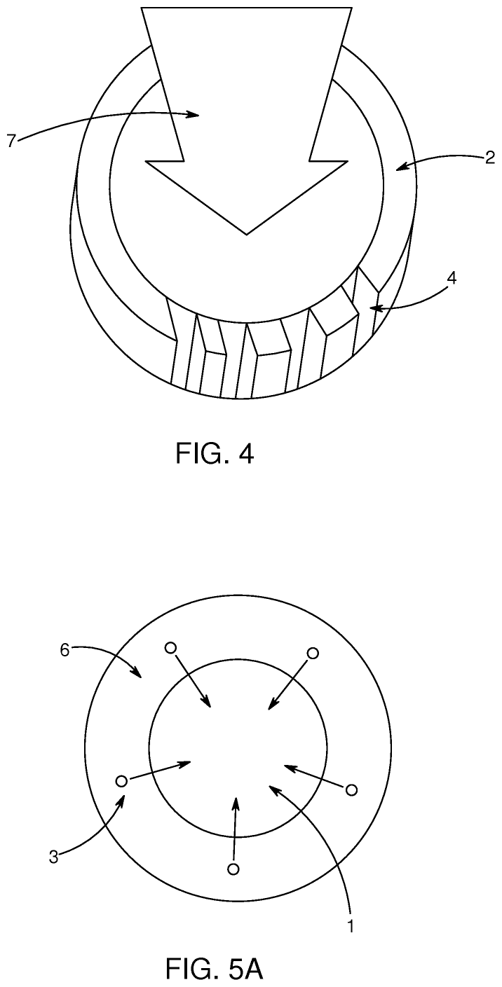

If the protrusion ring is combined with application of water and/or cleaning fluid the protrusion ring may comprise draining holes and/or draining slots (as indicated in FIG. 4) for evacuating cleaning liquid from the optical lens. In one embodiment, the system is configured to draw cleaning liquid away from the optical lens through the draining holes/slots.

The protrusion ring may also comprise a groove, such as a groove in an upper edge of the protrusion ring. In one embodiment a nozzle may run along the protrusion ring, thereby cleaning the lens from several directions. In such a solution the air flow may be transferred through the groove to the moving nozzle. The nozzle may be mounted on the protrusion ring and configured to rotate around the optical lens along the protrusion ring. The rotatable nozzle may be combined with other features such as a robotic arm holding the nozzle.

Ducts etc.

A further aspect of the air jet-based cleaning system relates to a plurality of nozzles distributed for operating with a plurality optical surfaces, and a plurality of ducts in connecting with the plurality of nozzles, wherein the plurality of ducts are integrated in a bodywork of a vehicle. Preferably, the nozzles are an integral part of the ducts.

The at least one duct may be seen as a pipe and/or tube. The plurality of ducts for distributing air to the nozzles may thereby he seen as a system of pipes and/or tubes for distribution of air to the nozzles. The at least one duet may comprise at least one guide vane for directing the air flow. The at least guide vane may be configured to compensate for placement of the nozzles in relation to the surface such that the air flow is more evenly distributed and the guide vanes may be adjustable for adapting the air flow to external conditions. The at least one guide vane may be arranged in the at least one duct or at an air outlet. The possibility to control the direction of the air flow may be useful for several reasons. It may be used for compensating for other aerodynamic effects such as side wind and/or for distributing the air flow more evenly over the surface or directing a more powerful air flow towards an area the needs to be cleaned more thoroughly. In one embodiment the guide vanes are adjustable.

The cleaning system may be arranged to make use, partly or completely, of the flow of air that is generated in relation the vehicle when the vehicle moves. A guiding structure may direct such an air flow to the at least one nozzle to clean the optical surface. In particular, if the outer protective cover layer is configured to cover the optical surface when the vehicle stands still and air generated by a motion of the vehicle is used, partly or completely, when the vehicle moves, a very power efficient solution is obtained.

The nozzle(s) and/or ducts may further comprise venturi tubes for increasing the speed of the ejected air. The venturi effect may moreover be used to allow a liquid to flow into a throat of the venturi in order to create small droplets, such as droplets having diameter less than 1 mm or less than 0.1 mm, in order to create a spray effect of a cleaning fluid.

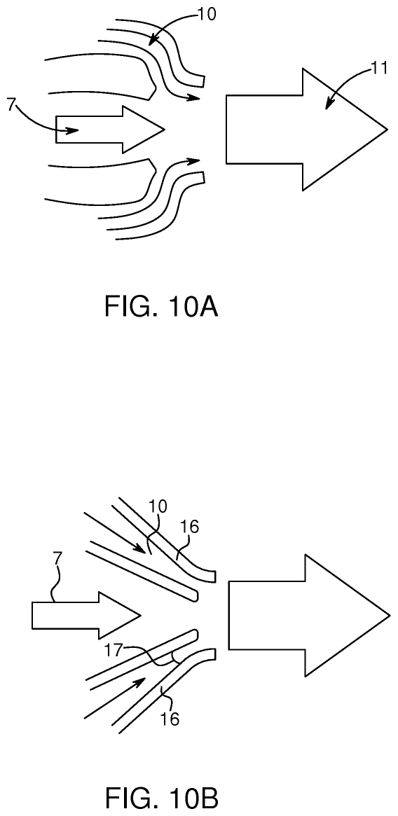

Cleaning fluid may be applied by the cleaning system for example by mixing the cleaning, fluid into the air jet. This can be performed inside the ducts by arranging the system for mixing air and cleaning fluid inside the at least one duct, or outside the cleaning system by applying the cleaning fluid and air simultaneously or alternating onto the surface. Air and cleaning fluid may be provided by a structure comprising an timer and an outer cone, as shown in FIG. 10B. The cones may form an inner an inner channel for air and an outer channel for cleaning fluid. If the angle between the inner and outer cones is adjustable the flow of fluid as well as the mixing can be adjusted. The nozzles may be adjustable to generate a number of different droplet sizes. For example a fine spray or a more powerful jet may be generated, which can have different purposes in a cleaning sequence. For example, in a first step, cleaning fluid can be distributed over the optical surface using a spray, and in a second step dirt can be removed using a jet.

Air Channels etc.

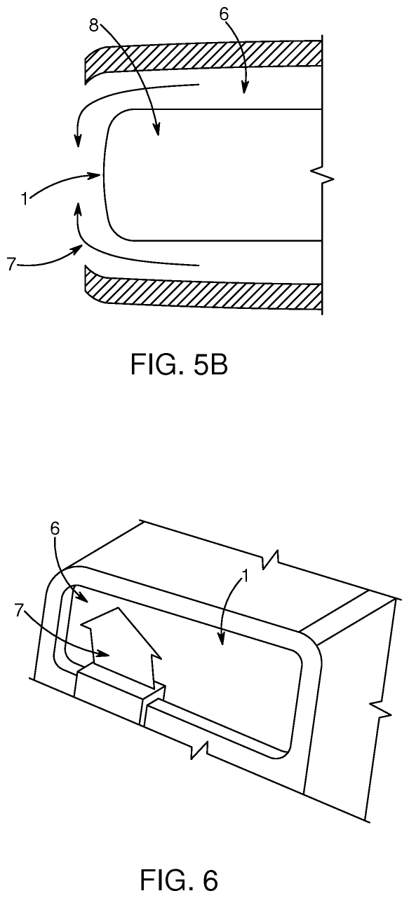

The provision of air to the nozzles through one or several ducts may be achieved in a solution that is partly or completely integrated with the camera or, sensor. As shown in FIGS. 5A-B the sensor may be provided with cables or wireless to reach a space behind an optical surface such as sensor cover. The air flow for cleaning the optical surface can then be provide in an outer channel, which may be a duct or an outer layer channel surrounding the inner layer. Therefore, in one embodiment of the system the at least one duct is/are provided in a channel along the longitudinal direction of the optical surface, such that the jet of air is transported forwards along the optical surface in the longitudinal direction.

Such a design may, also be useful for forming the air flow. In one embodiment the at least one nozzle is arranged to bend the jet of air around the contour of the optical surface towards the center of the optical surface. The jet of air may also be bent slightly backwards towards the optical surface or parallel to the surface to create an air curtain. In one embodiment the channel surrounds an inner channel arranged to provide cables to a sensor in a space behind the optical surface.

Flat, Optionally Rectangular, Surface

Another surface to be cleaned in for example autonomous vehicles is a flat and substantially rectangular surface behind which one or several sensors may be placed. The system may be adapted for, but is not limited to, such shapes and sizes of surfaces. For these surfaces the presently disclosed system for cleaning an optical surface may arranged such that the nozzle is arranged to move back and forth along on of the sides of the substantially rectangular optical surface while ejecting air over the surface as shown in FIG. 6.

In one embodiment of the presently disclosed system for cleaning an optical surface the plurality of nozzles arc arranged to eject overlapping jets and/or overlapping, air curtains of air at a plurality of distances from the optical surface. An example of such a configuration is shown in FIG. 7. The overlapping jets of air may be parallel to the optical surface, or at least having a small angle of incidence of the air jet in relation to the optical surface. The overlapping jets of air may also have different angles of incidence in relation to the optical surface.

Flat and elongated nozzles mat be suitable for distributing flowing air over a flat surface. The shapes of such elongate outlet of the nozzles may be further shaped to create air flow specifically adapted to the shape of the surface. This can be achieved by curved shapes and/or irregular shapes of the elongate outlets.

Cover Assembly

The disclosure further relates to a cover assembly for vehicle sensor(s) or image sensitivity part of a camera(s), comprising: at least one sensor or camera cover, preferably an optical surface for protecting the sensor or image sensitivity part of a camera; and at least one of the above nozzles for cleaning the at least one sensor or camera cover. A camera may in this context be seen as a device comprising an optical lens and light-sensitive media i.e. a sensor. The ‘cover’ of the cover assembly refers to the surface to be cleaned, which can either be in integral part of e.g. a camera, or delivered as only a surface and a nozzle as a kit, optionally further comprising the rest of the cleaning system as described in die present application.

The cover assembly may he seen as an integral solution, wherein a cover is provided with at least one the nozzles. The solution may further comprise ducts as described above. The actual sensor or camera may also be part of the assembly, either as a separate piece or attached and integrated with the rest of the assembly. Any part of the above described cleaning system for cleaning an optical surface may be part of the assembly.

In one embodiment of the cover assembly, the cover has been treated, or is made of, a hydrophobic material. More specifically, the at least one sensor or camera cover may have a surface having a suberhydrophobic nano- or microstructure or coating, such as a suberhydrophobic nano- or microstructure created by femtosecond laser pulsing. Superhydrophobic coating may be referred to as a nanoscopic surface layer that repels water,

The invention will in the following be described in greater detail with reference to the accompanying drawings. The drawings are exemplary and are intended to illustrate some of the features of the presently disclosed cleaning system, and are not to be construed as limiting to the presently disclosed invention.

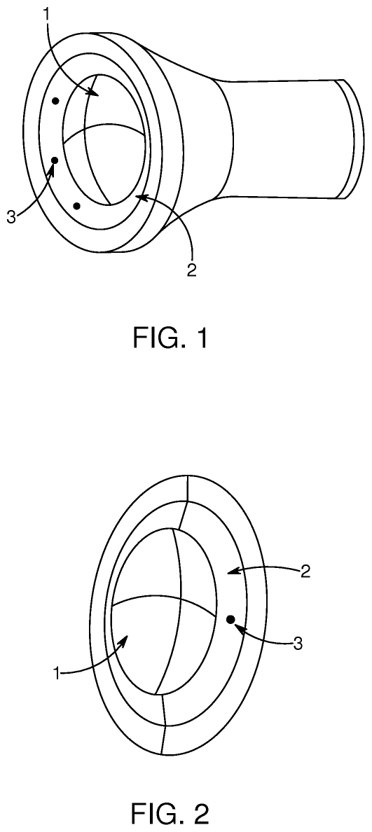

FIG. 1 shows an embodiment of the presently disclosed air jet-based cleaning system for an optical surface (1) having a protrusion ring (2) with a plurality of nozzles (3) distributed on the inside of the protrusion ring. A back part of the sensor housing has a cylindrical shape whereas the front part has a conical shape. Other shapes of the back part and cylindrical are envisaged.

FIG. 2 shows another embodiment of the presently disclosed air jet-based cleaning system with a nozzle (3) on the inside of the protrusion ring (2). The optical lens (1) is convex in this. example.

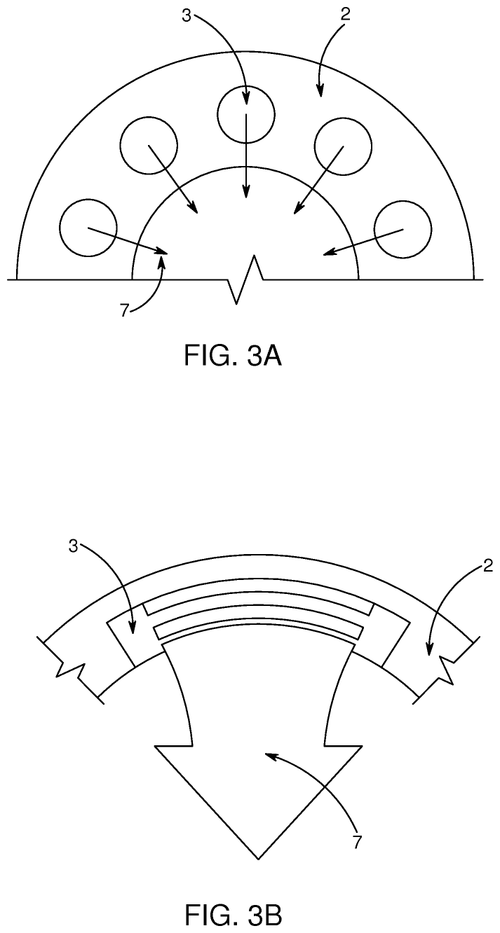

3A-B show different shapes of the nozzle(s) (3) on the protrusion ring (2). In FIG. 3, a plurality of nozzles (3) eject jets of air (7) towards the center of the optical surface. The nozzles would also be configurable to eject jets of air in other directions than towards the center of the optical surface, for example a number of nozzles creating parallel jets of air. In 3B one nozzle (3) has an elongate curved shape along the protrusion ring and ejects one broader jet of air (7). A straight elongate shape would also be possible

FIG. 4 shows an example of draining slots (4) on a lower part of the protrusion ring (4) for evacuating cleaning liquid from the optical lens (1). A jet of air (7) is ejected from a nozzle (not shown) from the upper part of the lens (1) to the lower part of the lens (1) where the draining slots (4) arc located.. The draining slots (4) could be located in other parts of the lens (1) depending on for example how the nozzle(s) is/are arranged.

FIG. 5A-B show an embodiment of the air jet-based cleaning system for an optical surface (1), wherein the duct (6) for providing the air flow is provided in a channel (6) along the longitudinal direction of the optical surface (1). FIG. 5A shows a front view cross-section wherein a plurality of nozzles (3) eject jets of air (7) towards the center of the optical surface, Alternatively the channel (6) may be used without nozzles through openings around the lens (1) in the front as shown in FIG. 5B. The ejected jets of air do not necessarily have to be bent towards the center of the optical surface.

FIG. 6 shows an embodiment of the air jet-based cleaning system for a substantially rectangular optical surface (1), wherein the nozzle (3) is arranged to move back and forth along on of the sides of the surface, A jet of air (7) is ejected over the surface (1).

FIG. 7 shows an embodiment of the air jet-based cleaning system for a substantially rectangular, slightly convex optical surface (1), wherein a plurality overlapping jets of air (7) are created at a plurality of distances from the optical surface, and at several positions along one of the sides of the surface.

FIG. 8A shows a first example of jets of air (7) towards the surface (1) from different angles (8,9) with respect to the optical surface (1). A tangent line denotes the reference corresponding to 0°, FIG. 8B shows a second example of jets of air (7) towards the surface (1), wherein the jets are perpendicular to the surface (1).

FIG. 9 shows an embodiment of the air jet-based cleaning system, wherein cleaning fluid and air are applied by two different nozzles, A jet of air (7) is ejected by a lower nozzle extending from edge to edge of the elongate nozzle. Cleaning fluid (10) is ejected by a higher nozzle extending from edge to edge of the elongate nozzle. The jet of air (7) and cleaning fluid (10) are combined to a mixture (11).

FIG. 10A shows an alternative embodiment of the air jet-based cleaning system arranged for mixing air and cleaning fluid inside the at least one duct. In this embodiment the cleaning fluid (10) is mixed into the channel for the flow of air (7) inside the cleaning system to provide a mixed stream (11) of air and cleaning fluid. FIG. 10B shows an embodiment of the air cleaning system comprising an inner channel for air and an outer channel for cleaning fluid. Both walls are substantially conical. The outer wall (16) has angle (17) relative to the inner wall. Preferably, the angle (17) of the conical outer channel in relation to the inner channel is adjustable.

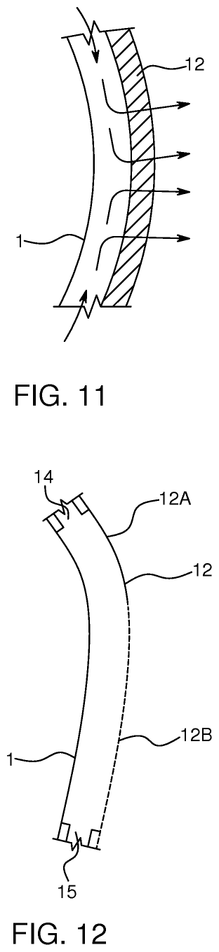

FIG. 11 shows an embodiment of the air jet-based cleaning system having an outer protective cover layer (12) wherein the protective cover layer (12) and optical surface (1) form a space. The cover layer (12) in this embodiment is air permeable. A nozzle may thereby be arranged to direct air into the space between the cover layer and optical surface in the closed configuration and out from the space through the air permeable outer protective cover layer (12).

FIG. 12 shows an embodiment of the air jet-based cleaning system having outer protective cover layer (12) mounted on the optical surface (1), the protective cove layer (12) and optical surface (1) forming a cleaning space. The cleaning space has at least one inlet (14) and at least one outlet (15). The protective cover layer (12) can be opened and closed. In the configuration of FIG. 12 the cover layer (12) partly covers the optical surface (1). The cover layer (12) can be further moved along the dotted line (12B) to cover the optical surface (1) completely.

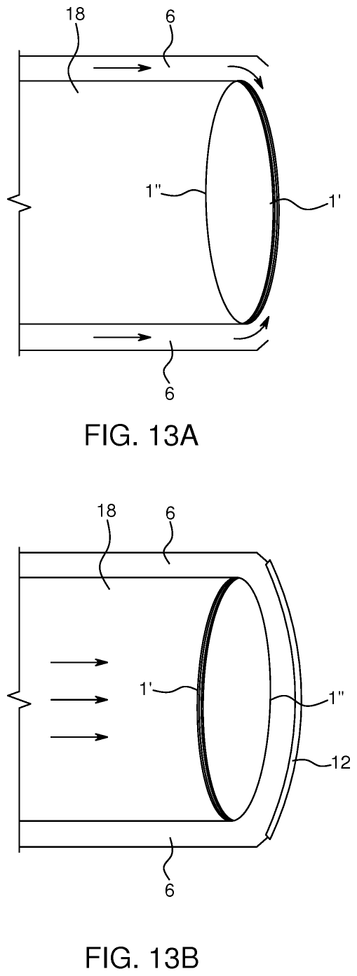

FIG. 13 shows an embodiment of the air-jet based cleaning system having a flip-over type optical surface (1). The surface has a first side (1′) and a second side (1′″). In the example the surface can he cleaned using a flow of air through duct (6) in an enabled configuration (shown in FIG. 13A). This may correspond to a mode wherein a sensor, which may be located in or behind the lens, is actively used in a vehicle. In FIG. 13B a cover 12 has been placed in front of the optical surface. If only the first surface (1′) needs to be kept clean, the cover (12) may not be needed. The configuration of FIG. 13B may correspond to a disabled mode, wherein the sensor is not used. In this mode the optical surface can be cleaned from an internal cleaning space (18).

Further Details of the Invention
1. A cleaning system for cleaning an optical surface, such as an optical lens of a vehicle camera or sensor, comprising:
   at least one nozzle arranged to eject a jet of air towards and/or parallel to the surface; and
   an outer protective cover layer, said cover layer mountable on the optical surface and configurable in:
      a closed configuration, wherein the cover layer and optical surface form a cleaning space between the cover layer and optical surface and the optical surface is protected by the protective cover layer; and
      an open configuration wherein the optical layer is exposed.
2. The cleaning system according to any of the preceding items, further comprising at least one air flow generator connected to the at least one nozzle trough at least one duct and arranged to generate an air flow to the at least one nozzle.
3. The cleaning system according to any of the preceding items, wherein the at least one nozzle is/are arranged to direct air into the space between the cover layer and optical surface in the closed configuration.
4. The cleaning system according to any of the preceding items, further comprising a control unit for controlling the open and closed configurations of the outer protective cover layer.
5. The cleaning system according to item 4, wherein the outer protective cover layer is configured to be in the open configuration when the vehicle moves, and/or configured to be in the closed configuration when the vehicle is in a neutral gear and/or when there, is no transmission of power to the motor of the vehicle, and/or when the motor does not run.
6. The cleaning system according to any of the preceding items, wherein the outer protective cover layer is air permeable and transparent and/or translucent.
7. The cleaning system according to claim 6, wherein the at least one nozzle is/are arranged to direct air into the space between the cover layer and optical surface in the closed configuration and out from the space through the air permeable outer protective cover layer.
8. The cleaning system according to any of the preceding items, where n the system is configured to turn optical surface away from external exposure.
9. The cleaning system according to any of the preceding items, wherein the optical surface is an integral part of the cleaning system, and wherein the optical surface is of a flip-over type which can turned away from external exposure,
10. The cleaning system according to any of items 7-9, where the system is configured to clean the optical surface from the inside, such as from an internal cleaning space, when the optical surface is configured away from external exposure.
11. The cleaning system according to any of the preceding items, wherein the air flow generator is low-pressure, high-flow air flow generator.
12. The cleaning system according to any of the preceding items, wherein the cleaning system is configured to direct air generated by a notion of the vehicle into the at the at least one nozzle to clean the optical surface.
13. The cleaning system according to any of the preceding, items, wherein the optical surface is cover, preferably a transparent and or translucent cover, of a sensor, and/or wherein the optical surface is an integral part of the sensor.
14. The cleaning system according to any of the preceding items, further comprising an arm for holding the at least one nozzle, wherein the nozzle is mounted at one end of the arm.
15. The cleaning system according to item 14, wherein the arm is adjustable and/or controllable to eject the jet of air from various angles and/or distances with respect to the optical surface.
16. The cleaning system according to any of the preceding items 4-15, wherein the arm is a robotic arm.
17. The cleaning system according to any of the preceding items, wherein size(s) of the at least open nozzles are adjustable.
18. The cleaning system according to any of the preceding items, wherein the at least open nozzles is/are adjustable to generate a fine spray or a jet, or a mixture of a fine spray and jet.
19. The cleaning system according to any of the preceding items, wherein the cleaning system comprises a plurality of nozzles and wherein groups of nozzles and/or individual nozzles are enabled and disabled and/or adjusted.
20. The cleaning system according to claim 19, wherein the groups of nozzles an or individual nozzles are enabled/disabled based on further sensor information,
21. The cleaning system according to any of the preceding items, the system configured for holding arid rotating the at least one nozzle around the optical surface.
22. The cleaning system according to any of the preceding items, wherein the cleaning system is arranged to generate at least one air curtain covering the optical surface.
23. The cleaning system according to any of the preceding items, wherein the cleaning system is arranged to generate a plurality of overlapping, air curtains covering the optical surface,
24. The cleaning system according to any of the preceding items, further arranged for ejecting a cleaning fluid in the jet of air.
25. The cleaning system according to any of the preceding items, wherein the optical surface is a substantially circular lens.
26. The cleaning system according to item 25, further comprising a protrusion ring around the circular lens, the protrusion ring protruding in the longitudinal projection direction of the lens.
27. The cleaning system according to any of preceding items 25-26, wherein the at least one nozzle is/are arranged in the protrusion ring and arranged to eject a jet of air towards the center of the optical surface and/or in one direction, such as upwards or downwards, or a combination.
28. The cleaning system according to any of preceding items 25-27, wherein a plurality of nozzles are distributed on the protrusion ring, preferably on the inside of the protrusion ring,
29. The cleaning system according to any of preceding items 25-28, wherein the at least one nozzle(s) have an elongate shape.
30. The cleaning system according to item 29, wherein the elongate shape is substantially straight or curved along the protrusion ring.
31. The cleaning system according to any of preceding items 29-30, wherein the elongate at least one nozzle is arranged to eject an air curtain over the surface.
32. The cleaning system according to any of preceding items 25-29, wherein the protrusion ring comprises draining holes and/or draining slots for evacuating cleaning liquid from the optical lens,
33. The cleaning system according to item 32, wherein the system is configured to draw cleaning liquid as from the optical lens through the draining holes/slots.
34. The cleaning system according to any of preceding items 25-32, wherein the nozzle is mounted on the protrusion ring and configured to rotate around the optical lens along the protrusion ring.
35. The cleaning system according to item 34, wherein the nozzle is arranged to run in a groove in the protrusion ring.
36. The cleaning system according to any of the preceding items, comprising a plurality of nozzles distributed for operating with a plurality optical surfaces, and a plurality of ducts in connecting with the plurality of nozzles,
37. The cleaning system according to item 36, wherein the plurality of ducts are integrated in a bodywork of a vehicle,
38. The cleaning system according to any of the preceding items, wherein the nozzles are an integral part of the duets.
39. The cleaning system according to any of the preceding, items, further comprising at least one guide vane for directing the air flow,
40. The cleaning system according to item 39, wherein the at least one guide vane is arranged in the at least one duct or at an air outlet,
41. The cleaning system according to any of items 39-40, wherein the at least guide vane is configured to compensate for placement of the nozzles in relation to the surface such that the air flow is more evenly distributed.
42. The cleaning system according to any of items 40-41, wherein the guide vanes are adjustable for adapting the air flow to external conditions.
43. The cleaning system according to any of the preceding items, further comprising a guiding structure configured to direct air generated by a motion of the vehicle into the at the at least one nozzle to clean the optical surface.
44. The cleaning system according to any of the preceding items, the nozzle(s and/or ducts comprising venturi tubes for increasing the speed of the ejected air.
45. The cleaning system according to any of the preceding items, wherein the nozzles are configured, such that the angle between the optical surface and an outlet direction of the jet of air is 0-±30°, preferably 0-±20°, more preferably 0-±10°, even more preferably 0-±5°.
46. The cleaning system according to any of items 1-44, wherein the nozzles are configured to generate a jet of air directly towards the optical surface in a direction substantially perpendicular to the optical surface.
47. The cleaning system according to any of the preceding items, wherein the at least one duct is/are provided in a channel along the longitudinal direction of the optical surface, such that the jet of air is transported forwards along the optical surface in the longitudinal direction.
48. The cleaning system according to item 47, wherein the at least cine nozzle is arranged to bend the jet of air around the contour of the optical surface towards the center of the optical surface.
49. The cleaning system according to any of items 47-48, wherein the channel surrounds an inner channel arranged to provide cables to a sensor in a space behind the optical surface.
50. The cleaning system according to any of the preceding items for substantially rectangular optical surface.
51. The cleaning system according to item 50, wherein the nozzle is arranged to move back and forth along on of the sides of the substantially rectangular optical surface.
52. The cleaning system according to any of the preceding items, wherein a plurality of nozzles are arranged to eject overlapping jets of air at a plurality of distances from the optical surface.
53. The cleaning system according to item 52, wherein the overlapping jets of air are parallel to the optical surface.
54. The cleaning system according to any of the preceding items, further arranged for ejecting carbon dioxide in the jet of air.
55. The cleaning system according to item 54, wherein the carbon dioxide is provided as pellets or compressed liquid or gaseous carbon dioxide.
56. The cleaning system according to any of items 54-55, the system arranged for applying carbon dioxide in predefined time intervals and/or upon a sensor indicating a need for more efficient cleaning of the optical surface and/or at request of a user.
57. The cleaning system according to any of the preceding items, arranged for mixing air and cleaning fluid inside the at least one duct or arranged for mixing air and cleaning fluid outside the cleaning system.
38. The cleaning system according to claim 57, wherein the system comprises an inner channel for air and an outer channel for cleaning fluid.
59. The cleaning system according to item 58, wherein the outer channel has a tapered, such as conical shape.
60. The cleaning system according to item 58, wherein an angle of the conical outer channel in relation to the inner channel is adjustable.
61. A cover assembly for vehicle sensor(s) or image sensitivity part of a camera(s), comprising;
   at least one sensor or camera cover, preferably an optical surface for protecting the sensor or image sensitivity part of the camera;
   at least one nozzle according to any of items 1-57 for cleaning the at least one sensor or camera cover.
62. The cover assembly according to item 61, further comprising a sensor or camera, wherein the sensor or camera is part of the sensor or camera cover or a separate part.
63. The cover assembly according to any of items 61-62, comprising the cleaning system for cleaning an optical surface according to any of items 1-57.
64. The cover assembly according to any of items 61-63, wherein the at least one sensor or camera cover comprises a hydrophobic material.
65. The cover assembly according to any of items 61-64, wherein the least one sensor or camera cover has a surface having a suberhydrophobic nano- or microstructure, such as a suberhydrophobic nano- or microstructure created by femtosecond laser pulsing.

1. A cleaning system for cleaning an optical surface, such as an optical lens of a vehicle camera or sensor of a vehicle, comprising:
at least one nozzle arranged to eject a jet of air towards and/or parallel to the optical surface; and
an outer protective cover layer, said cover layer mountable on the optical surface and configurable in:
a closed configuration, wherein the cover layer and optical surface form a cleaning space between the cover layer and optical surface and the optical surface is protected by the protective cover layer; and
an open configuration wherein the optical layer is exposed.

2. The cleaning system according to claim 1, further comprising a control unit for controlling the open and closed configurations of the outer protective cover layer.

3. The cleaning system according to claim 2, wherein the outer protective cover layer is configured to be in the open configuration when the vehicle moves, and/or configured to be in the closed configuration when the vehicle is in a neutral gear and/or when there is no transmission of power to a motor of the vehicle, and/or when the motor docs not run.

4. The cleaning system according to claim 1, wherein the outer protective cover layer is air permeable and transparent and/or translucent.

5. The cleaning system according to claim 4, wherein the at least one nozzle is/arc arranged to direct air into the cleaning space between the cover layer and optical surface in the closed configuration and out from the cleaning space through the air permeable outer protective cover layer.

6. The cleaning system according to claim 1, wherein the system is configured to turn the optical surface away from external exposure.

7. The cleaning system according to claim 1, wherein the optical surface is an integral part of the cleaning system, and wherein the optical surface is of a flip-over type which can turned away from external exposure.

8. The cleaning system according to claim 1, further comprising an air flow generator being a low-pressure, high-flow air flow generator.

9. The cleaning system according to claim 1, wherein the cleaning system is configured to direct air generated by a motion of the vehicle into the at the at least one nozzle to dean the optical surface.

10. The cleaning system according to claim 1, wherein the optical surface is a cover, preferably a transparent and/or translucent cover, of a sensor, and/or wherein the optical surface is an integral part of the sensor.

11. The cleaning system according to claim 1, wherein the cleaning system comprises a plurality of nozzles and wherein groups of the plurality of nozzles and/or individual ones of the plurality of nozzles are enabled and disabled and/or adjusted.

12. The cleaning system according to claim 11, wherein the groups of the plurality of nozzles and/or individual ones of the plurality of nozzles are enabled/disabled based on further sensor information.

13. The cleaning system according to claim 1, wherein the cleaning system is arranged to generate at least one air curtain covering the optical surface.

14. The cleaning system according to claim 1, wherein the cleaning system is arranged to generate a plurality of overlapping air curtains covering the optical surface.

15. The cleaning system according to claim 1, wherein the optical surface is a substantially circular lens, further comprising a protrusion ring around the circular lens, the protrusion ring protruding in a longitudinal projection direction of the lens, wherein the at least one nozzle comprising a plurality of nozzles distributed on the protrusion ring, preferably on the inside of the protrusion ring.

16. The cleaning system according to claim 1, wherein the at least one nozzle comprises a plurality of nozzles distributed for operating with a plurality optical surfaces, and further comprising a plurality of ducts in connecting with the plurality of nozzles.

17. The cleaning system according to claim 16, wherein the plurality of ducts are integrated in a bodywork of the vehicle.

18. The cleaning system according to claim 16, wherein the nozzles are an integral part of the ducts.

19. A cover assembly for a vehicle sensor(s) or an image sensitivity part of a camera(s), comprising:
at least one sensor or camera cover, preferably an optical surface for protecting the sensor or image sensitivity part of the camera;
at least one nozzle according to claim 1 for cleaning the at least one sensor or camera cover.
